(19) United States
(12) Patent Application Publication
(10) Pub. No.: US 2010/0132740 A1
(43) Pub. Date: Jun. 3, 2010

(54) Method and system for the treatment of excretion containers

(76) Inventors: Denis Lehmann, Ortenberg (DE); Michael Streb, Iffezheim (DE); Marcus Braun, Offenburg (DE); Heinz-Peter Werner, Filzmoos (AT)

Correspondence Address: Muncy, Geissler, Olds & Lowe, PLLC, 4000 Legato Road, Suite 310, FAIRFAX, VA, 22033, US

(21) Appl. No.: 11/914,387

(22) PCT Filed: Apr. 4, 2006
(86) PCT No.: PCT/EP06/03931

§ 371 Date: Jul. 30, 2008

(30) Foreign Application Priority Data
May 11, 2005 (DE) 10 2005 022 634.5

(51) Int. Cl. A61G 9/02; B08B 9/093

(52) U.S. Cl. 134/13; 134/22.18; 134/50

(57) ABSTRACT

Particularly in hospitals, care homes or similar institutions, it is necessary to have a safely handled and reliable method for the emptying and cleaning of excretion containers, for example urine bottles or bedpans. A method and a system (110) are therefore proposed, by means of which such articles to be rinsed (112) can be treated. In this case, first, in an emptying step (210), the articles to be rinsed (112) are emptied and are rinsed out with a rinsing-out liquid. Subsequently, in a circulation step (212), the articles to be rinsed (112) are washed in circulation. Finally, a rinsing-clear step (214) is carried out, in which the articles to be rinsed (112) are rinsed with a rinsing-clear liquid. Then, in an optional disinfection step (216), preferably a chemical disinfection step (216), the articles to be rinsed (112) are disinfected, and, in an optional drying step (218), the articles to be rinsed (112) are dried by being blown off with heated air.

### FIELD OF THE INVENTION

The invention relates to a method and a system for the treatment of excretion containers, for example medical excretion containers, in particular bedpans, urine bottles, suction bottles or similar medical containers which are designed for the reception of relatively large liquid quantities. Methods and systems of this type can be employed, in particular, in hospitals, care homes or similar institutions.

### PRIOR ART

Various devices and methods for cleaning containers, in particular medical liquid containers, are known from the sector of medical plant technology. Thus, for example, DE 37 09 020 A1 discloses a washing and rinsing apparatus for the cleaning of containers and appliances, such as, for example, for the emptying, rinsing and washing of bedpans. The apparatus comprises a washing and/or rinsing chamber, a water box, one or more valves for the infeed of water from the network into the apparatus, a pump for the circulation of water in the apparatus, a stench trap and an outflow duct. In this case, in a rinsing phase, first, network water is introduced into the water box, from where it is conveyed via an intermediate chamber into the washing and/or rinsing chamber. After the rinsing phase, the containers are cleaned in circulation by means of a small water quantity.

DE 24 60 065 C2 discloses a sanitary rinsing apparatus, in which a rinsing chamber is connected to an outflow via a stench trap. In this case, a first pipe section connected to the rinsing chamber acts as a water reservoir and is connected to a circulating pump via a line. In this case, too, in a similar way to that described in DE 37 09 020 A1, first fresh water is applied to the articles to be rinsed in order to remove coarse impurities. Subsequently, the outflow connection piece is filled with warm water and circulation is started. A disinfection rinsing step with heated water then takes place.

A method and a device for cleaning and disinfection of containers are known from DE 198 38 180 C2. In this method, first, the container is again emptied and prerinsed, in that it is sprayed continuously with freshly supplied cleaning liquid, the contaminated cleaning liquid being discharged continuously via an outflow of the rinsing device. Subsequently, the outflow of the rinsing device is closed, and a predetermined quantity of cleaning or disinfecting liquid is introduced into the rinsing chamber, the container subsequently being cleaned in circulation. Finally, hot steam is introduced into the rinsing chamber, moist air being sucked away from the chamber via a pump.

However, the devices and methods known from the prior art have numerous disadvantages in practical use. A substantial disadvantage is, in particular, that emptying and cleaning typically take place by the articles to be rinsed being sprayed out or rinsed, followed by a disinfection of the articles to be rinsed by hot steam or chemicals. However, in particular the separate disinfection step entails high energy consumption and/or high environmental pollution and often leads to unsatisfactory results, since, for example, dirt particles still adhering to the articles to be rinsed prevent a complete disinfecting action.

Furthermore, after the articles to be rinsed have been treated with circulation water, residues from this circulation water often remain behind, after the end of the circulation step, on the articles to be rinsed. Consequently, however, residues of the dissolved dirt particles from the circulation water are also often left behind on the articles to be rinsed. This, too, has the effect that the cleaning and disinfecting action of the devices and methods known from the prior art is not sufficiently ensured.

If methods are employed in which a disinfection of the articles to be rinsed is carried out by a disinfectant being admixed to the circulation water, then, to achieve a sufficient disinfecting action, it is necessary to have a sufficient concentration of the disinfectant in the circulation water. In order to ensure this sufficient concentration, as a rule, a large quantity of disinfectant has to be used. This increases costs and environmental pollution.

Furthermore, in the methods and systems known from the prior art, rinsing out the articles to be rinsed and washing them in circulation are carried out via the same nozzle systems. This means, however, that, in terms of the design of these nozzle systems, a compromise, for example a compromise with regard to throughflow quantity, spray-on angle or cleanliness, has to be reached for the various method steps.

Moreover, the systems known from the prior art entail the risk that, particularly in circulation, the circulation system may be blocked by dirt. In particular, sieves in the suction-intake region of the circulation system may easily become clogged in this case.

Furthermore, the use of identical system parts for different process steps involves an intermingling of the different hygiene states of the individual process steps. Thus, the respective hygiene state cannot be defined or guaranteed during or after the respective process steps.

### OBJECT OF THE INVENTION

An object of the present invention, therefore, is to provide a method and a system for the cleaning of containers, in particular for the cleaning and treatment of excretion containers, which avoid the disadvantages of the systems and methods known from the prior art. In particular, the method is to be suitable for the cleaning, disinfection and drying of excretion containers, such as, for example, bedpans, urine bottles or suction bottles.

### PRESENTATION OF THE INVENTION

What is therefore proposed is a method for the treatment of excretion containers and a corresponding system which, for example, using the method according to the invention, can be employed for the cleaning of excretion containers. In this case, the term “excretion container” is to be interpreted broadly and is to embrace liquid containers, in particular liquid containers which are suitable for the reception of relatively large liquid quantities. In particular, these may be medical liquid containers, in particular excretion containers, such as, for example, bedpans, urine bottles, suction bottles or similar containers. The term “articles to be rinsed” is to be used below, in general, for these.

The method is to have the following steps, and the method steps illustrated below are preferably, but not necessarily, to be carried out in the order illustrated. Furthermore, additional method steps not listed may also be carried out, and individual method steps may, for example, be carried out in parallel or repeatedly.

In a first method step (emptying step), the articles to be rinsed, which have at least one excretion container, are emptied. Furthermore, the at least one excretion container is rinsed out with a rinsing-out liquid which preferably has water. During emptying, for example, the articles to be rinsed may additionally be tilted, and liquid may, for example, be emptied into an outflow. In a second step (circulation step), the at least one excretion container is washed in circulation. Subsequently, in a rinsing-clear step, the articles to be rinsed are rinsed with a rinsing-clear liquid which preferably has water. Optionally, thereafter, in a drying step, the at least one excretion container may be dried by being blown off with heated air.

An essential feature of the invention is that, in the method according to the invention, cleaning in the circulation step is the center point of the method and is a main focus of the cleaning of the articles to be rinsed. In the method according to the invention, an additional disinfection step is not required, but may optionally be employed. A fundamental idea of the invention is that only an efficient removal of all the impurities adhering to the articles to be rinsed makes it reasonably possible to carry out subsequent disinfection. Systems known from the prior art mostly misjudge this aspect and are based correspondingly on an intensive disinfection step. The experts are prejudiced in thinking that the disinfection step is the main cleaning process. In this disinfection step, the dirt particles still adhering and other impurities are in most cases simply additionally “disinfected”, essentially germs in these dirt particles being killed. Such disinfection usually requires high temperatures and/or the use of large amounts of chemical disinfectants, in order to achieve even a certain degree of efficiency. The cleaning methods correspondingly become uneconomic and complicated. Pollutants contained in the dirt particles, however, are still not or only insufficiently rendered harmless. The cleaned articles to be rinsed therefore still have adhering (but “disinfected”) dirt particles.

By contrast, in the method according to the invention, the reliable removal of dirt and dirt residues from the articles to be rinsed is a simple precondition for the optimal treatment of the articles to be rinsed. Consequently, the precondition for high process reliability is afforded, and high efficiency in economic and ecological terms is achieved. Reliably cleaned articles to be rinsed are a precondition for process reliability for (optional) subsequent disinfection of the articles to be rinsed by hot steam or chemicals.

In order to employ such a cleaning of the articles to be rinsed, the circulation step is the center point of the method according to the invention. In contrast to the prior art, this circulation step is carried out in such a way that the articles to be rinsed are mechanically processed and cleaned by the circulation water. This cleaning takes place with high physical intensity, for example by continuous or intermittent spraying with circulation water. It is particularly preferable, in this case, if the circulation water is sprayed onto the articles to be rinsed with a pressure at the circulation nozzles of approximately 0.8 bar (with a tolerance of preferably no more than 0.2 bar) and a jet volume of 5-10 l/min water quantity per circulation nozzle. For this purpose, correspondingly configured circulation nozzles may be used which, in particular, spray onto the “critical” locations of the articles to be rinsed. Rotatable or pivotable nozzles may also be employed. Preferably, in this case, a circulation pump with the highest possible pump power is used.

In addition to high physical intensity, the duration of the cleaning step in circulation is also preferably increased, as compared with the methods known from the prior art. Thus, it is preferable, if this cleaning step in circulation amounts to at least 25% of the overall method duration, preferably at least 50% and particularly preferably at least 75% of the overall method duration.

The fact that the cleaning of the articles to be rinsed in circulation is the center point of the method according to the invention ensures a reliable rinsing out of the articles to be rinsed and a reliable removal of dirt residues and therefore an optimal disinfection and good drying of the articles to be rinsed. High hygiene safety, along with favorable operating costs, is thus ensured. Despite the increased technical outlay for circulation (in the form of higher-powered circulation pumps etc.), operating costs can be lowered, since complicated subsequent disinfection steps may be dispensed with, or since these may have a correspondingly smaller dimensioning. Thus, for example, a cost-intensive steam generator or other thermal disinfection devices used frequently for disinfection in the prior art may be dispensed with, with the result that the process duration and operating costs can be lowered considerably. The use of circulation instead of continuous spraying with fresh water, often adopted in the prior art, ensures a high cleaning performance, at the same time with low water consumption, thus also considerably increasing the environmental compatibility of the method. The time duration and the intensity of the circulation step may also be adapted, for example, to the type of articles to be rinsed or to the type of dirt. For example, in a program control of the method, specific classes of articles to be rinsed or of impurities may be provided which are selected by a user, with the result that the time duration and intensity of the circulation step are automatically adapted correspondingly.

In the rinsing-clear step according to the invention, following the circulation step, the at least one excretion container is rinsed with a rinsing-clear liquid, preferably water or a rinsing-clear liquid having water. For example, for this purpose, the same system may be used which has also been used for rinsing out. Preferably, this rinsing-clear step is carried out after the circulation step. In this case, an additional rinsing-clear agent, for example a surfactant, may also be added to the rinsing-clear liquid. Preferably, however, fresh water is used. In this rinsing-clear step, in particular, residues of the circulation water and dirt residues (for example, proteins) dissolved therein are rinsed off from the articles to be rinsed and are washed away. According to the invention, the rinsing-clear step is particularly effective only when solid dirt residues have previously been loosened mechanically from the articles to be rinsed by means of correspondingly long and physically active circulation. These dirt residues are then present predominantly in solution or as a suspension in the circulated liquid. The rinsing-clear step then has essentially merely the function of displacing dirty circulation water, which has dissolved impurities and which wets the surfaces of the articles to be rinsed, by clean rinsing-clear liquid, so that dissolved or suspended dirt residues cannot adhere to or dry on the surfaces again.

The method according to the invention may be optimized further by means of additional method steps. Thus, the method may additionally have a disinfection step in which the at least one excretion container is disinfected. This is preferably a chemical disinfection step. Alternatively or additionally, however, for example, a thermal disinfection step, for example a steam sterilization step, may also be employed, although this is not preferred for operational reasons and, because of the more thorough mechanical cleaning of the articles to be rinsed, is not required. In a chemical disinfection step, the at least one excretion container can be wetted with a disinfectant, preferably a disinfection solution. It is particularly preferred, in this case, if the disinfection solution is applied, preferably sprayed, to the at least one excretion container, the at least one excretion container being (completely or partially) wetted with a film of the disinfectant.

It is particularly preferable if in each case individually preset water quantities are provided for the different method steps (with the exception of the drying step) in a fresh water storage tank. This ensures that the articles to be rinsed are always rinsed under uniform conditions. This configuration of the method is particularly simple to implement in process terms.

Furthermore, the method may be extended in that, in the circulation step, the articles to be rinsed are wetted completely or partially with cleaning solution, preferably highly concentrated cleaning solution. A film of the cleaning solution is preferably in this case formed on the articles to be rinsed. For example, wetting may take place by spraying on. Wetting may take place, in particular, independently of circulation. The cleaning solution in this case takes effect on the articles to be rinsed preferably as a full concentrate. In this case, in particular, circulation may be interrupted while the cleaning solution is being sprayed on. A repeated interruption of circulation with a repeated spraying on of cleaning solution is also possible. The particularly preferred highly concentrated cleaning solution may have, for example, a solution of cleaning agent of at least 0.3 to 0.5% by weight in a solvent, preferably water.

A further embodiment of the invention relates to the circulation itself. In this case, it is preferable if circulated washing liquid is routed through a comminutor, particles contained in the circulated washing liquid being comminuted. This prevents dirt particles from blocking the circulation system, for example nozzles of the circulation system, and thus from putting operating reliability at risk. Additionally or alternatively, at least one circulation filter may also be employed, which filters the circulated washing liquid. In this case, preferably, a backwash system may additionally be provided, the at least one circulation filter being backwashed after the end of the circulation operation, for example dirt particles contained in the filter being rinsed out into the outflow.

Furthermore, a system for the treatment of articles to be rinsed is proposed, and in this case the articles to be rinsed are to have at least one excretion container according to the above definition. The system has at least one cleaning chamber for receiving the articles to be rinsed. Moreover, the system has at least one emptying system for emptying the articles to be rinsed into at least one outflow. The at least one emptying system is equipped with at least one tank for receiving a rinsing-out liquid and at least one pipeline system connecting the tank to the at least one cleaning chamber. The at least one pipeline system has at least one rinsing-out pump and at least one rinsing-out nozzle. In this context, the term “nozzle” is in this case and in the following cases to be interpreted broadly. In particular, nozzle orifices and the type and configuration of these nozzles may be adapted to the respective intended use. Thus, a nozzle may have, for example, a single orifice to the cleaning chamber. However, more complex nozzle systems with a plurality of fine orifices, directed spray systems, spray arms, pivoting systems or the like are also possible. As a result, in particular, the angle and the velocity at which the respective liquid is sprayed onto the articles to be rinsed can be set.

Furthermore, the system according to the invention has at least one circulation system with at least one circulation tank for receiving a circulation liquid. Also, at least one pipeline system connecting the circulation tank to the at least one cleaning chamber and having at least one circulation pump and at least one circulation nozzle is provided.

Moreover, the system according to the invention has at least one active substance system for applying an active substance to the articles to be rinsed. The active substance system has itself at least one active substance pipeline system, at least one active substance pump, at least one active substance nozzle system and at least one active substance tank.

Optionally, furthermore, the system has at least one drying system with at least one suction-intake line connected to the at least one cleaning chamber with at least one heating device and at least one blower and also at least one drying nozzle.

In this case, as already described above, the system is preferably configured in such a way that the at least one circulation system and the at least one active substance system are separate systems. Preferably, the at least one emptying system and the at least one drying system also form separate systems. In particular, in this case, the pipeline systems and the nozzle systems and also the pumps of said systems may be configured as different components. As described above, this ensures a high degree of hygiene, since the individual cleaning stages are carried out separately and no contamination of subsequent method steps by preceding “dirtier” method steps can take place. This is often not the case in systems known from the prior art, in which, for example, the same pipeline systems are used for circulation and for disinfection. This in many instances leads, in practice, to a renewed contamination of the articles to be rinsed, after the cleaning has actually already been carried out. By the systems being separated according to the invention, this is avoided. Only “clean” processes can be carried out by means of the same spray systems, for example an emptying step and a rinsing-clear step.

The at least one circulation tank may, in particular, be formed integrally in the at least one cleaning chamber. Thus, the at least one circulation tank may have, for example, a bottom region of the at least one cleaning chamber, for example a bottom region of funnel-shaped configuration of the at least one cleaning chamber, for example the funnel-shaped region issuing into the at least one outflow. Furthermore, the pipeline system of the at least one circulation system may have, as described above, a comminution device for comminuting particles contained in the circulation water.

Advantageously, the active substance system has at least one treatment tank connectable to the at least one cleaning chamber, the treatment tank being capable of being filled with fresh water of a predetermined quantity. Furthermore, this at least one treatment tank is to be connectable to a storage container for cleaning solution and/or a storage container for disinfectant. In this case, the at least one treatment tank may, in particular, be configured in such a way that it is connected to a fresh water storage tank via a barrier. A water quantity in the at least one treatment tank can be settable via the height of this barrier.

As described above in connection with the method according to the invention, the at least one circulation system may have, furthermore, at least one circulation filter. In this case, it is advantageous if the at least one circulation system has, furthermore, at least one backwash system, the at least one circulation filter being capable of being backwashed via the at least one backwash system.

Further details and features of the invention may be gathered from the following description of preferred exemplary embodiments in conjunction with the subclaims. In this case, the respective features may be implemented each in themselves or several in combination with one another. The invention is not restricted to the exemplary embodiments.

The exemplary embodiments are illustrated diagrammatically in the figures. The same reference numerals in the individual figures in this case designate identical or functionally identical elements or elements corresponding to one another in terms of their functions.

In particular, in the figures,

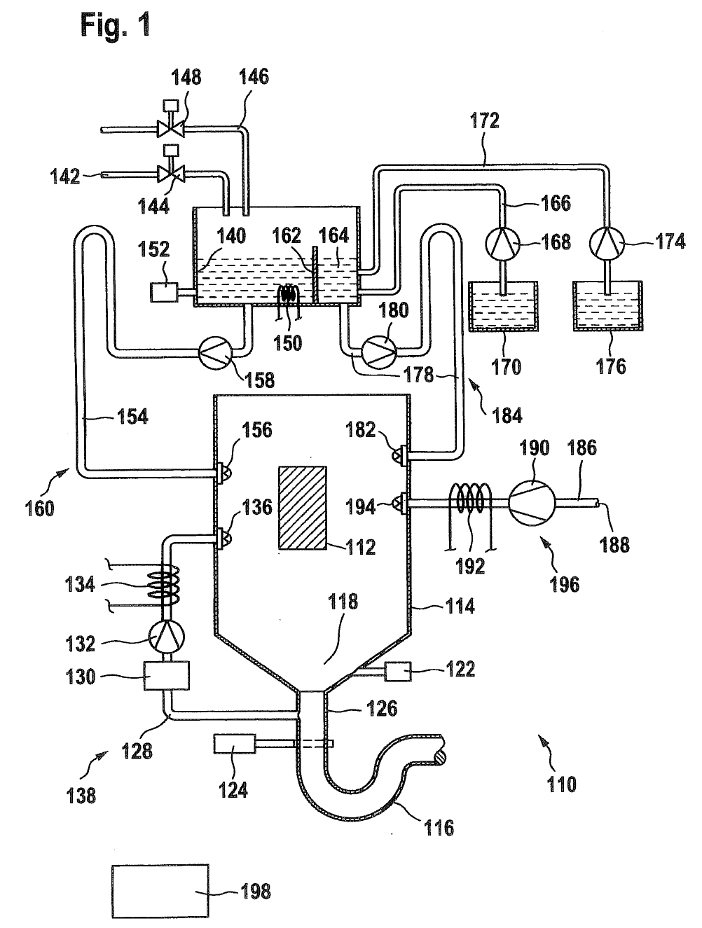

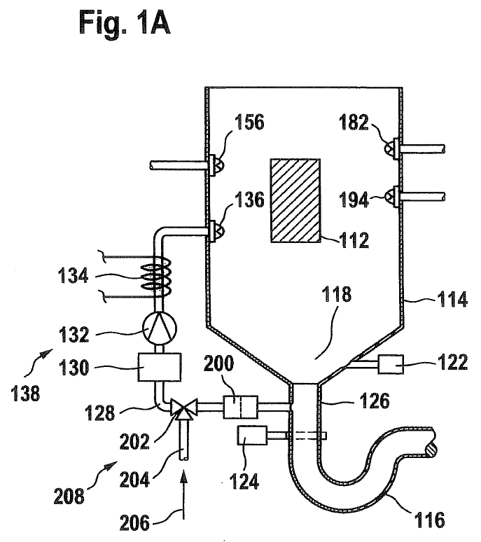

FIG. 1 shows an exemplary embodiment of a system according to the invention for the treatment of articles to be rinsed;

FIG. 1A shows a preferred modified version of the system according to FIG. 1; and

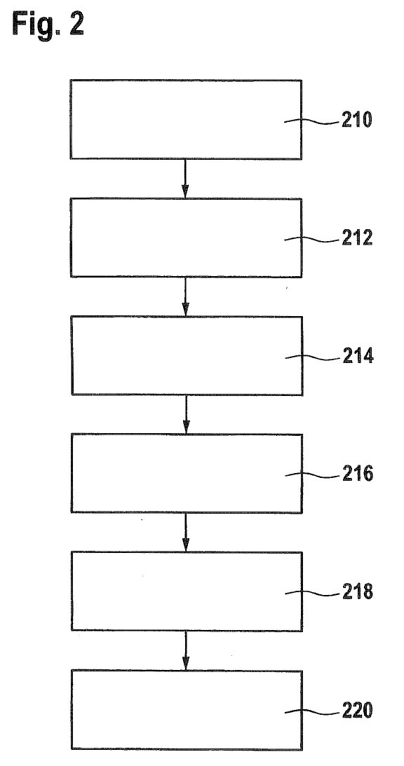

FIG. 2 shows a diagrammatic flow chart of a method according to the invention for the treatment of articles to be rinsed.

FIG. 1 illustrates an exemplary embodiment of a system 110 for the treatment of articles to be rinsed 112, in particular excretion containers. The central element of the system 110 is a cleaning chamber 114 which receives the articles to be rinsed 112. In this case, the articles to be rinsed 112 may be received, for example, rigidly or pivotably, the latter, for example, for emptying, in a stand (not illustrated).

The cleaning chamber 114 is a funnel-shaped configuration at its lower end and issues into an outflow 116 which is connected, for example, to a sewerage system. A circulation tank 118 is formed in the region of the funnel-shaped configuration of the cleaning chamber 114. Arranged in the region of the circulation tank 118 is a level sensor 122, via which a liquid level in the circulation tank 118 can be detected electronically. Furthermore, the circulation tank can be closed downwardly with respect to the outflow 116 by means of a valve 124.

Directly above the valve 124, a circulation pipeline system 128 branches off from a connection piece region 126 of the circulation tank 118. The circulation pipeline system 128 has a comminutor 130 for the comminution of larger dirt particles, a circulation pump 132 and a heating device 134. The circulation pipeline system 128 issues, finally, into the cleaning chamber 114 via a circulation nozzle system 136. The circulation tank 118, circulation pipeline system 128, circulation pump 132 and circulation nozzle system 136 and also the other components 130, 134 mentioned are integral parts of a circulation system 138.

Furthermore, the system 110 has a water tank 140 which can be filled with fresh water via a cold-water line 142 having a cold-water valve 144 and via a hot-water line 146 having a hot-water valve 148. Moreover, the water tank 140 has a heating device 150 and a level sensor 152. The water tank 140 is connected to the cleaning chamber 114 via a rinse-out pipeline system 154 and a rinse-out nozzle system 156. A rinse-out pump 158 is integrated into the rinse-out pipeline system 154. The water tank 140, rinse-out pipeline system 154, rinse-out nozzle system 156 and rinse-out pump 158 are integral parts of a rinse-out system 160. Furthermore, like the circulation system 138 described above, the rinse-out system 160 may also have additional valves, for example shut-off valves, which are not illustrated in FIG. 1.

A treatment tank 164 is separated from the water tank 140 by a mechanical barrier 162, preferably a height-adjustable barrier 162. The treatment tank 164 is connected via a first connecting line 166, into which a first metering pump 168 is integrated, to a storage container 170 for a cleaning agent. Furthermore, the treatment tank 164 is connected via a second connecting line 172, into which a second metering pump 174 is integrated, to a storage container 176 for disinfectant. In addition, valves, which are not illustrated in FIG. 1, may also be integrated into the connecting lines 166, 172.

The treatment tank 164 is connected via an active substance pipeline system 178, into which an active substance pump 180 is integrated, and via an active substance nozzle system 182 to the cleaning chamber 114. The treatment tank 164, active substance pipeline system 178, active substance pump 180 and active substance nozzle system 182 thus form integral parts of an active substance system 184, via which, selectively, cleaning solution and/or disinfectant solution can be supplied to the cleaning chamber 114. Furthermore, the active substance system 184 may also have one or more valves, for example shut-off valves.

Moreover, in the exemplary embodiment according to FIG. 1, the system 110 has a suction-intake line 186 which can suck in ambient air, for example, at a suction-intake end 188. A suction-intake pump 190, which functions as a drying blower 190, is integrated into the suction-intake line 186. Moreover, heating 192 is integrated into the suction-intake line 186. The heating 192 and drying blower 190 may be configured as one component or as separate components. The suction-intake line 186 issues via a drying nozzle 194 into the cleaning chamber 114. The suction-intake line 186, drying blower 190, heating 192 and drying nozzle 194 form integral parts of a drying system 196.

As described above, the individual nozzle systems 136, 156, 182, 194 may be configured in various ways. In this case, the individual nozzle systems 136, 156, 182, 194 are adapted optimally to the respective intended use which is described in more detail below. This means, in particular, that, for example, the rinse-out nozzle system 156 allows an optimal rinsing out of the articles to be rinsed 112. For this purpose, the rinse-out nozzle system 156 must be oriented correspondingly with the articles to be rinsed 112. The other nozzle systems are also oriented appropriately and correspondingly configured in one part or in a plurality of parts. The functionality of the overall system 110, that is to say, for example, the functionality of the valves, for example of the valves 124, 144, 148, and of the other valves mentioned, and the functionality of the pumps 132, 158, 168, 174, 180, 190 and of the heating elements 134, 150, 192 may be controlled by means of a central control 198. This central control can also, for example, process signals from various sensors arranged in the system, for example the level sensors 122 and 152. The sequence of the individual program steps, which are described in more detail further below, is also controlled by the central control 198. For example, the central control 198 may have a microcomputer or other computer systems.

FIG. 1A illustrates a detail of a preferred exemplary embodiment of a system 110 according to the invention for the treatment of articles to be rinsed, which differs from the system 110 illustrated in FIG. 1 merely in the configuration of the circulation system 138. In this case, the circulation pipeline system 128 has as additional components a circulation filter 200, a 3/2-way valve 202 and a backwash line 204. The backwash line 204 can be acted upon via a pressure system, not illustrated, with backwash pressure (symbolized in FIG. 1A by reference symbol 206). The 3/2-way valve 202, which may again be controlled, for example, via the central control 198, can be switched in such a way that the pipe section of the circulation pipeline system 128 into which the circulation filter 200 is integrated can be connected selectively either to the backwash line 204 or to that section of the circulation pipeline system 128 into which the circulation pump 132 is integrated. The 3/2-way valve 202 and the backwash line 204 thus form integral parts of a backwash system 208, by means of which the circulation filter 200 can be backwashed into the outflow 116. The backwash pressure 206 may be generated, for example, by a separate pump system or, for example, also simply by means of a connection to a water supply system which provides, for example, fresh water under pressure. Also, one of the pumps described above, for example the circulation pump 132, may be utilized, by means of suitable valve switching, for generating a backwash pressure 206.

By means of the system illustrated in FIG. 1 or FIG. 1A, for example, the preferred exemplary embodiment, described below, of a method according to the invention for the treatment of articles to be rinsed 112 can be carried out. As described above, the illustrated order of process steps is a preferred order which, however, does not restrict the scope of the invention.

An emptying step 210 is carried out as the first method step of the method according to the invention. For this purpose, first, articles to be rinsed 112, which are to have at least one excretion container, are introduced into the cleaning chamber 114. The cleaning chamber 114 is subsequently closed, for example by means of a closing mechanism, not illustrated in FIG. 1, for example a door. The closing mechanism may be configured, for example, such that the articles to be rinsed 112 are automatically emptied into the outflow 116 as a result of the closing of the cleaning chamber 114. In this case, for example, a holder may be used, in which the articles to be rinsed 112 are mounted such that a closing of the cleaning chamber 114 automatically causes a tilting of the articles to be rinsed 112, with the result that the liquid contents of the articles to be rinsed 112 are emptied into the outflow 116.

Subsequently, the overall cleaning program is started by the central control 198. The above-described step of emptying the articles to be rinsed may likewise be controlled by the central control 198.

A rinsing-out operation then commences, likewise as an integral part of the emptying step 210. In this case, the water tank 140 is filled with a first water quantity via the cold-water valve 144 and/or the hot-water valve 148. Preferably, in this case, cold water is employed for reasons of energy saving. During the filling of the water tank 140, the water level rises and finally reaches the height of the barrier 162 and overshoots this.

Water from the water tank 140 is sprayed via the rinse-out pump 158 and the rinse-out nozzle system 156 onto the articles to be rinsed 112. In this case, loosely adhering coarse dirt is rinsed off. This dirt is discharged, together with the sprayed water, via the outflow 116. The abovementioned first water quantity is dimensioned exactly this way and the rinse-out nozzles 156 are arranged and dimensioned such that a sufficient washout of impurities from the articles to be rinsed 112 occurs when the latter are sprayed out once only.

Furthermore, cleaning agent can be supplied via the first metering pump 168 and/or disinfectant via the second metering pump 174 to the treatment tank 164 which, as described above, is filled with water when the barrier 162 is overshot. Thus, a corresponding active substance solution, which has selectively cleaning agent and/or disinfectant, can be generated in the treatment tank 164. This active substance solution may optionally, even in the emptying step 210, be sprayed out onto the articles to be rinsed 112 via the active substance system 184 by means of the active substance nozzle system 182. As a result, even in the first program step 210, the emptying action can be optimized and dirt particles adhering to the articles to be rinsed 112 can be minimized. Optionally, however, as described above, the emptying step 210 may also take place simply by spraying out with pure water.

In the following method step 212, a circulation step is carried out. It is advantageous, at the start of the circulation step 212, to wait until the sprayed-out water used in the emptying step 210 has run off completely via the outflow 116. Subsequently, the water tank 140 is filled with hot water of a second water quantity via the hot-water valve 148 and/or the cold-water valve 144. Preferably, in this method step, hot water is used. Furthermore, the outflow 116 is shut off with respect to the circulation tank 118 by means of the valve 124. The water from the water tank 140 is introduced into the cleaning chamber 114 via the rinse-out pump 158 and via the rinse-out nozzle system 156. However, since the outflow 116 is shut off by the valve 124, this water cannot flow out via the outflow 116, but, instead, collects in the circulation tank 118. The circulation pump 132 conveys the water out of the circulation tank 118 to the circulation nozzle system 136 which sprays the water onto the articles to be rinsed 112. As described above, in this case, preferably a nozzle pressure of approximately 0.8 bar and a jet volume of 5-10 l/min per circulation nozzle 136 are adopted. Water dripping off from the articles to be rinsed 112 falls back into the circulation tank 118 again and is sucked in once more by the circulation pump 132. In order to increase the cleaning action during circulation, the temperature of the water may be increased via the heating device 134.

Since the situation is not ruled out where coarse dirt still adheres in the circulation step 212 to the articles to be rinsed 112 and could be loosened and circulated during the circulation step 212 and possibly block the circulation nozzle system 136, the circulation pipeline system 128 has provided in it the comminutor 130. This has the effect that all the dirt residues are comminuted to an extent such that the circulation nozzle system 136 is not blocked.

During circulation, cleaning agent and/or disinfectant from the treatment tank 164 may also be applied via the active substance nozzle system 182 to the articles to be rinsed 112 and thus be added to the circulated water quantity. This optional development of the circulation step 212 may advantageously take place in that, during the circulation step 212, the circulation process is interrupted after a first time segment. During this interruption, in particular, cleaning solution in a high concentration or of another composition (for example, a strong acid or base) may be sprayed from the treatment tank 164 via the active substance nozzle system 182 onto the articles to be rinsed 112, these being wetted. Since the circulation water is largely received in the circulation tank 118 during the interruption in the circulation operation, cleaning agent of high concentration therefore passes onto the articles to be rinsed 112. The result of this high concentration is that dirt coatings easily come loose even during a short action time. Subsequently, after an appropriate action time, circulation may be continued. This interruption and the spraying on of cleaning agent may optionally be repeated a plurality of times. Subsequently, once again, circulation is continued and actual cleaning is terminated.

After the conclusion of circulation, for example after a predetermined circulation time duration which may be stored, in particular, in the central control 198, circulation is finally terminated. In this case, the valve 124 in the outflow 116 is opened, with the result that circulation water can flow out from the circulation tank 118 through the outflow 116. The operation of the circulation pump 132 may then also be stopped.

In an optional rinsing-clear step 214 following the circulation step 212, the articles to be rinsed 112 are subsequently rinsed clear. In this case, the residues of the circulation water, together with dirt residues dissolved therein, are washed out from the articles to be rinsed 112. For this purpose, in the rinsing-clear step 214, the water tank 140 is filled with water of a third water quantity via the cold-water valve 144 and/or the hot-water valve 148. Optionally, as also in preceding steps in which the water tank 140 has been used, this fresh water may additionally be heated by means of the heating device 150. Subsequently, via the rinse-out pump 158, this fresh water from the water tank 140 is applied via the rinse-out nozzle system 156 to the articles to be rinsed 112, these preferably being sprayed out and the articles to be rinsed 112 being rinsed off. The rinsing-clear water dripping off is discharged via the outflow 116. Optionally, in this step, a rinsing-clear solution may also be supplied from the treatment tank 164 via the active substance system 184, in which case preferably a third storage container for a rinsing-clear liquid may also be provided in addition to the storage containers 170 and 176. An additional connecting line and an additional metering pump and also corresponding additional valves may in this case also be provided.

The rinsing-clear step 214 is followed, in the method flow according to FIG. 2, by an optional disinfection step 216. In this disinfection step 216, disinfection solution is sprayed from the treatment tank 164 via the active substance nozzle system 182 by means of the active substance pump 180 onto the articles to be rinsed 112. This disinfection solution has previously been prepared in the treatment tank 164. For this purpose, for example, an additional fresh water quantity may be fed into the treatment tank 164 from the water tank 140 over the barrier 162 via the valves 144, 148. It is particularly preferred, however, if, even in the rinsing-clear step 214 described above, the third water quantity is dimensioned such that a corresponding water quantity has flowed out of the water tank 140 over the barrier 162 into the treatment tank 164. Thus, in particular after the end of the method, the water tank 140 is emptied completely. In the disinfection step 216, this overflowed water quantity can then be mixed in the treatment tank 164 with disinfectant from the storage container 176. Preferably, in this case, a disinfection solution of high concentration is used, which is sprayed, finely distributed, via the active substance nozzle system 182 onto the articles to be rinsed 112. An optimal disinfecting action can thereby be achieved. Excess disinfection solution subsequently runs out via the outflow 116.

After the disinfection step 216, a drying step 218 is carried out. In this drying step 218, ambient air is sucked in via the suction-intake line 186 by means of the drying blower 190. The air is heated by means of the heating 192 and is blown via the drying nozzle system 194 onto the articles to be rinsed 112. Once again, the drying nozzle system 194 and the drying blower 190 are dimensioned and oriented such that an optimal drying action on the articles to be rinsed 112 is achieved.

FIG. 2 also gives an optional backwash step 220 as the last method step. This backwash step 220 may regularly be carried out after the method according to steps 210 to 218 or may also be carried out, for example, at regular or irregular time intervals under the control of the central control 198. Alternatively or additionally, this backwash step 220 may also be carried out after the circulation step 212. For this backwash step 220, it will be assumed below that the embodiment of the system 110, as illustrated in FIG. 1A, is employed. In this backwash step 220, for example after the circulation step 212, the valve 124 is opened again after the end of the circulation step 212, so that circulation water 118 can flow out completely into the outflow 116. The valve 124 subsequently remains open. The 3/2-way valve 202 is then switched such that that section of the circulation pipeline system 128 into which the circulation filter 200 is inserted is connected to the backwash line 204. By contrast, the remaining circulation pipeline system 128 is separated from the abovementioned components by means of 3/2-way valve 202. Backwash liquid, for example fresh water, can then be pressed under backwash pressure 206 through the backwash line 204 opposite to the direction of circulation through the circulation filter 200. As a result, dirt particles deposited in the circulation filter 200 are rinsed out and washed into the outflow 116. The circulation filter 200 is thereby cleaned. The circulation pressure 206 may, for example, prevail permanently on the backwash line 204 or, alternatively, may also be generated only at the commencement of the backwash step 220, for example by a backwash pump being switched on correspondingly.

### LIST OF REFERENCE SYMBOLS

110 System for the treatment of articles to be rinsed
112 Articles to be rinsed
114 Cleaning chamber
116 Outflow
118 Circulation tank
122 Level sensor
124 Valve
126 Connection piece region of the circulation tank
128 Circulation pipeline system
130 Comminutor
132 Circulation pump
134 Heating device
136 Circulation nozzle system
138 Circulation system
140 Water tank
142 Cold-water line
144 Cold-water valve
146 Hot-water line
148 Hot-water valve
150 Heating device
152 Level sensor
154 Rinse-out pipeline system
156 Rinse-out nozzle system
158 Rinse-out pump
160 Emptying system
162 Barrier
164 Treatment tank
166 First connecting line
168 First metering pump
170 Storage container for cleaning agent
172 Second connecting line
174 Second metering pump
176 Storage container for disinfectant
178 Active substance pipeline system
180 Active substance pump
182 Active substance nozzle system
184 Active substance system
186 Suction-intake line
188 Suction-intake end
190 Drying blower, suction-intake pump
192 Heating
194 Drying nozzle
196 Drying system
198 Central control
200 Circulation filter
202 3/2-way valve
204 Backwash line
206 Backwash pressure
208 Backwash system
210 Emptying step
212 Circulation step
214 Rinsing-clear step
216 Disinfection step
218 Drying step
220 Backwash step

1-20. (canceled)

21. A method for the treatment of articles to be rinsed having at least one excretion container, a cleaning chamber configured to be used for receiving the articles to be rinsed, which has a circulation tank and an outflow with a valve, the method comprising:
a) an emptying step, the articles to be rinsed being emptied and being rinsed out with a rinsing-out liquid, which has water, via an emptying system, and rinsing-out liquid used running off via the outflow;
b) a circulation step carried out by a circulation system, at the commencement of the circulation step the outflow being shut off with respect to the circulation tank by the valve, the articles to be rinsed being washed in circulation, and subsequently the valve being opened again, so that circulation water can flow out via the outflow;
c) a rinsing-clear step, the articles to be rinsed being rinsed with a rinsing-clear liquid which has water; and
d) a drying step carried out by a drying system, the articles to be rinsed being dried by being blown off with heated air,
wherein separate systems are used for emptying system, circulation system and drying system.

22. The method as claimed in claim 1, wherein the duration of method step b) forms at least 25% of the overall method duration, at least 50% of the overall method duration, or at least 75% of the overall method duration.

23. The method as claimed in claim 1, wherein, in method step b), circulation liquid with a nozzle pressure of between 0.6 and 1.0 bar, preferably with a nozzle pressure of 0.8 bar, and a jet volume in the range of between 5 and 10 l/min per circulation nozzle is sprayed onto the articles to be rinsed.

24. The method as claimed in claim 1, further comprising:
e) a disinfection step, the articles to be rinsed being wetted with at least one disinfectant, preferably a disinfection solution, preferably a highly concentrated disinfection solution.

25. The method as claimed in claim 1, wherein individual preset water quantities are provided in a fresh water storage tank for different method steps.

26. The method as claimed in claim 1, wherein, in method step b), the articles to be rinsed are wetted with cleaning solution, preferably highly concentrated cleaning solution.

27. The method as claimed in claim 1, wherein circulation is interrupted during spraying on.

28. The method as claimed in claim 1, wherein, in method step b), circulated washing liquid is routed through a comminutor, particles contained in the circulated washing liquid being comminuted.

29. The method as claimed in claim 1, wherein, in method step b), circulated washing liquid is filtered.

30. The method as claimed in claim 1, further comprising:
f) a backwash step, at least one circulation filter being backwashed after the end of the circulation operation.

31. A device for the treatment of articles to be rinsed comprising at least one excretion container, the device being set up, having a correspondingly set-up control in order to carry out the method as claimed claim 1.

32. The device according to claim 31, further comprising:
a) at least one cleaning chamber for receiving the articles to be rinsed;
b) at least one emptying system for emptying the articles to be rinsed into at least one outflow, with at least one tank for receiving a rinsing-out liquid, at least one pipeline system connecting the tank to the at least one cleaning chamber and having at least one rinse-out pump and at least one rinse-out nozzle;
c) at least one circulation system with at least one circulation tank for receiving a circulation liquid, at least one pipeline system connecting the circulation tank to the at least one cleaning chamber and having at least one circulation pump and at least one circulation nozzle; and
d) at least one active substance system for applying an active substance to the articles to be rinsed, with at least one active substance pipeline system, at least one active substance pump, at least one active substance nozzle system and at least one active substance tank,
e) at least one drying system with at least one suction-intake line connected to the at least one cleaning chamber, with at least one heating device and at least one blower and at least one drying nozzle,
the at least one circulation system, the at least one active substance system, the at least one emptying system and the at least one drying system constituting separate systems.

33. The device according to claim 31, wherein at least one circulation tank is formed integrally in the at least one cleaning chamber.

34. The device according to claim 31, wherein the pipeline system of the at least one circulation system has at least one comminution device.

35. The device according to claim 31, wherein the active substance system has at least one treatment tank connectable to the at least one cleaning chamber, the at least one treatment tank being capable of being filled with fresh water of a predetermined quantity, and the at least one treatment tank being connectable, furthermore, to at least one of the following elements: a storage container for a cleaning agent or a storage container for disinfectant.

36. The device according to claim 31, wherein the at least one treatment tank is connected to a fresh water storage tank via a barrier, a water quantity in the at least one treatment tank being settable via the height of the barrier.

37. The device according to claim 31, wherein the at least one circulation system has, furthermore, at least one circulation filter.

38. The device according to claim 31, wherein the at least one circulation system has, furthermore, at least one backwash system, the at least one circulation filter being capable of being backwashed via the at least one backwash system.
